(19) United States
(12) Patent Application Publication
(10) Pub. No.: US 2019/0101688 A1
(43) Pub. Date: Apr. 4, 2019

(54) PLANAR LIGHT SOURCE DEVICE AND LIQUID CRYSTAL DISPLAY DEVICE

(71) Applicant: SHARP KABUSHIKI KAISHA, Sakai City, Osaka (JP)

(72) Inventors: MASAKAZU KOMANO, Sakai City (JP); MAKOTO HIBITANI, Sakai City (JP)

(21) Appl. No.: 16/087,048

(22) PCT Filed: Mar. 21, 2017
(86) PCT No.: PCT/JP2017/011277

§ 371 Date: Sep. 20, 2018

(30) Foreign Application Priority Data
Mar. 25, 2016 (JP) 2016-062760

(51) Int. Cl. F21V 8/00; G02F 1/1335

(52) U.S. Cl. CPC G02B 6/0055; G02F 1/133606; G02B 6/0066

(57) ABSTRACT

An embodiment of the present invention reduces difference in brightness between a portion where a tab of an optical sheet is formed and a portion where the tab is not formed. A frame (3) of a planar light source device (1) has an inclined surface (13) formed so as to incline with respect to a direction perpendicular to a light exit plane and to face in a direction opposite to the light exit plane. The inclined surface (13) is formed at least at a portion where a cut part (17) is not formed, which portion is part of a surface (12) of the frame (3) which surface (12) faces a lateral surface (11) of a light guide plate (2). At a bottom surface (14) of the frame (3), a light absorbing member (6) is provided.

### TECHNICAL FIELD

The present invention relates to a planar light source device and a liquid crystal display device including the planar light source device.

### BACKGROUND ART

Mobile information devices such as laptop personal computers, personal data assistants (PDAs), portable game machines, and mobile phones are prevailing in recent years. Liquid crystal display devices (LCDs) are widely used as displays of these mobile information devices. An LCD is basically constituted by a backlight section and a liquid crystal display element section, and includes a planar light source device as the backlight section and a liquid crystal panel as the liquid crystal display element section.

The planar light source device includes: a light guide plate; a light source provided on a side surface of the light guide plate; a resin frame in which the light guide plate is provided; and an optical sheet provided on the light guide plate. In the planar light source device, when the light source is caused to emit light, the light from the light source goes into the light guide plate of the planar light source device. Then, the light is multiply reflected in the light guide plate. Subsequently, the light thus reflected exits through the light exit plane of the light guide plate. Thereafter, the light having exited from the light guide plate is collected by the optical sheet, so that the liquid crystal panel is irradiated with the light thus collected.

The light multiply reflected inside the light guide plate may leak out of the light guide plate through a plane other than the light exit plane. There have been techniques employed for reflecting such leakage light back into the light guide plate or for absorbing the leakage light. For example, Patent Literature 1 discloses a method using a light shielding film having a light absorbing plane and a light reflecting plane. According to the method, the light shielding film is bonded to at least a portion of a surface of a thin optical film opposed to a light source such that the light absorbing plane faces the light source.

### CITATION LIST

### Patent Literature

[Patent Literature 1] Taiwan Patent Publication No. 480349

### SUMMARY OF INVENTION

### Technical Problem

However, in regard to a liquid crystal display device provided with a planar light source device as disclosed in Patent Literature 1, when a periphery of a screen is obliquely viewed from an inner side of the screen, a portion where a tab of the optical sheet is formed appears darker than another portion(s) of the screen.

This is for the following reason. A portion where the tab of the optical sheet is not formed appears brighter, because of light which have leaked out of the light guide plate and further exited through the light exit plane. In contrast, at the portion where the tab of the optical sheet is formed, there is less light which has leaked out of the light guide plate and exited through the light exit plane. As a result, the portion where the tab of the optical sheet is formed noticeably appears darker as compared to the portion where the tab of the optical sheet is not formed.

The present invention is attained in view of the above problem. An object of the present invention is to provide a planar light source device and a liquid crystal display device, each of which makes it possible to reduce difference in brightness between a portion where a tab of an optical sheet is formed and a portion where the tab is not formed.

### Solution to Problem

In order to solve the above problem, a planar light source device in accordance with an aspect of the present invention is configured to include: a light source which emits light outside; a light guide plate which causes the light to exit outside through a light exit plane while guiding the light; a frame in which the light source, the light guide plate, and the optical sheet are provided, the frame having a cut part in which a tab of the optical sheet is fit; and a light absorbing member provided on a bottom surface of the frame, the frame having an inclined surface formed so as to incline with respect to a direction perpendicular to the light exit plane and to face in a direction opposite to the light exit plane, the inclined surface being formed at least at a portion where the cut part is not formed, the portion being part of at least one surface of the frame, the at least one surface of the frame facing a lateral surface of the light guide plate.

### Advantageous Effects of Invention

An aspect of the present invention advantageously makes it possible to reduce difference in brightness between a portion where a tab of an optical sheet is formed and a portion where the tab is not formed.

### BRIEF DESCRIPTION OF DRAWINGS

FIG. 1 is a view schematically illustrating a cross section of a planar light source device in accordance with Embodiment 1 of the present invention.

FIG. 2 shows an overall view of the planar light source device in accordance with Embodiment 1 of the present invention and an enlarged view of a region A.

FIG. 3 is a view schematically illustrating a cross section of a portion of a frame at which portion a cut part is not formed, in the planar light source device in accordance with Embodiment 1 of the present invention.

FIG. 4 is a cross sectional view illustrating a portion of the frame in accordance with Embodiment 1 of the present invention, at which portion an inclined surface is formed.

FIG. 5 is a view schematically illustrating a cross section of a planar light source device in accordance with Embodiment 2 of the present invention.

FIG. 6 is a view schematically illustrating a cross section of a planar light source device in accordance with Embodiment 3 of the present invention.

### DESCRIPTION OF EMBODIMENTS

### Embodiment 1

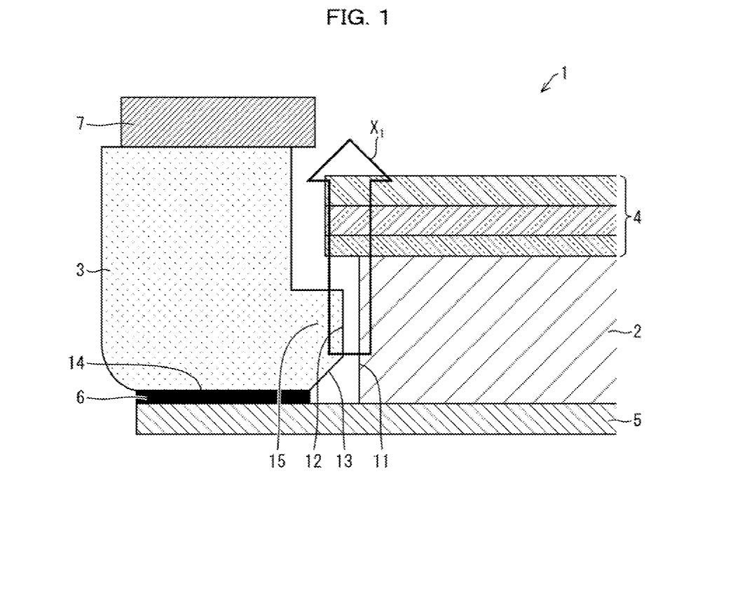

The following will discuss Embodiment 1 of the present invention, with reference to FIGS. 1 to 4.

### Configuration of Planar Light Source Device 1

A liquid crystal display device (LCD) is basically constituted by a backlight section and a liquid crystal display element section, and includes a planar light source device as the backlight section and a liquid crystal panel as the liquid crystal display element section. With reference to FIG. 1, the following will discuss a brief overview of a planar light source device in accordance with Embodiment 1 of the present invention. FIG. 1 is a view schematically illustrating a cross section of a planar light source device 1.

As illustrated in FIG. 1, the planar light source device 1 includes a light guide plate 2, a frame 3, an optical sheet 4, a reflection sheet 5, a light absorbing member 6, a light shielding tape 7, and a light source (not illustrated). At a bottom surface of the frame 3, the light absorbing member 6 is provided. The frame 3 is provided on the reflection sheet 5 via the light absorbing member 6. On the light guide plate 2, the optical sheet 4 is provided. The frame 3 is provided so as to house the light guide plate 2 and the optical sheet 4. The light shielding tape 7 is provided on a top surface of the frame 3.

The planar light source device 1 includes, as a light source, a light emitting diode (LED), a laser diode (LD), a cold cathode fluorescent lamp (CCFL), or the like. The planar light source device 1 can be a direct-type planar light source. In this case, a light source is provided right below an LCD. Alternatively, the planar light source device 1 can be an edge-light-type planar light source device in which a light source is provided on a side surface of the light guide plate 2.

When the light surface is caused to emit light, the light from the light source goes into the light guide plate 2 of the planar light source device 1. Then, the light form the light source is multiply reflected in the light guide plate 2. Thereafter, the light is caused to exit outside through a surface (light exit plane) of the light guide plate 2 which surface is on a liquid crystal panel (not illustrate) side. Subsequently, the light having exited from the light guide plate 2 is collected by the optical sheet 4 and the liquid crystal panel is irradiated with the light thus collected. In this way, the light from the light source is efficiently guided to the liquid crystal panel side by the light guide plate 2 and collected by the optical sheet 4. This consequently makes an illuminance distribution uniform in the planar light source device 1, so that the liquid crystal panel can be irradiated with uniform light.

In general, the optical sheet 4 is supported by the frame 3 and includes a diffusing sheet, a lens sheet, and/or the like. Types of the optical sheet 4 include, for example, a biprism type which includes two diffusing sheets and two lens sheets having respective prism patterns orthogonal to each other between the two diffusing sheets. Types of the optical sheet 4 also include a reverse prism type which includes one lens sheet having a prism pattern facing downward.

The reflection sheet 5 reflects light having leaked out of the light guide plate 2 on a reflection sheet 5 side of the light guide plate 2 so that the light will return back into the light guide plate 2. Moreover, the light absorbing member 6 absorbs light having leaked out through a lateral surface 11 of the light guide plate 2. Further, the light shielding tape 7 prevents light from the light guide plate 2, with which light the liquid crystal panel is to be irradiated, from leaking out to a portion where light is not necessary.

### Configuration of Frame 3

The light guide plate 2 is housed in the frame 3. The frame 3 has surfaces 12 opposed to lateral surfaces 11 of the light guide plate 2 (hereinafter, referred to as opposed surfaces 12), one or more of which opposed surfaces 12 are inclined. Specifically, the frame 3 has an inclined surface 13 that inclines with respect to a direction perpendicular to the light exit plane, at least at a portion of at least one of the opposed surfaces 12. The inclined surface 13 faces in a direction (reflection sheet 5 side) opposite to the light exit plane. In FIG. 1, a bottom portion of the frame 3 has a shape including a protrusion 15 that protrudes toward the light guide plate 2. At least one opposed surface 12 of the protrusion 15 is provided with the inclined surface 13.

Part of light having entered the light guide plate 2 from the light source leaks out through a surface of the light guide plate 2 which surface is on the reflection sheet 5 side of the light guide plate 2 and through the lateral surface 11 of the light guide plate 2. The light having leaked out on the reflection sheet 5 side is reflected by the reflection sheet 5 and caused to return back into the light guide plate 2 again. Thereafter, the light having returned back into the light guide plate 2 is multiply reflected in the light guide plate 2 and caused to exit on a light exit plane side.

Meanwhile, the light having leaked out through the lateral surface 11 of the light guide plate 2 is reflected by the opposed surface 12 of the frame 3 and caused to return back into the light guide plate 2. Thereafter, the light having returned back into the light guide plate 2 is multiply reflected in the light guide plate 2 and caused to exit on the light exit plane side. Note however that part of the light having leaked out through the lateral surface 11 of the light guide plate 2 does not return back into the light guide plate 2 after reflected by the opposed surface 12 of the frame 3, and such part of the light exits on the light exit plane side.

The frame 3 in accordance with Embodiment 1 of the present invention has an inclined surface 13 that is inclined with respect to a direction perpendicular to the light exit plane, at least at a portion of at least one of the opposed surfaces 12. Accordingly, part of the light having leaked out through the lateral surface 11 of the light guide plate 2 enters a gap between the inclined surface 13 of the frame 3 and the reflection sheet 5, and then the light is absorbed by the light absorbing member 6. This makes it possible to prevent the light having leaked out through the lateral surface 11 of the light guide plate 2 from exiting on the light exit plane side.

Note that the light absorbing member 6 can be, for example, a double-sided black tape. This allows the light absorbing member 6 to have both of (i) a function as a member for absorbing the light having leaked out through the lateral surface 11 of the light guide plate 2 and (ii) a function as a member for fixing the reflection sheet 5 to the bottom surface of the frame 3. However, the light absorbing member 6 is not limited to such a configuration. The light absorbing member 6 is not specifically limited as long as the light absorbing member 6 is a member capable of absorbing light, such as a member made of a black resin, or the like.

### Position of Inclined Surface

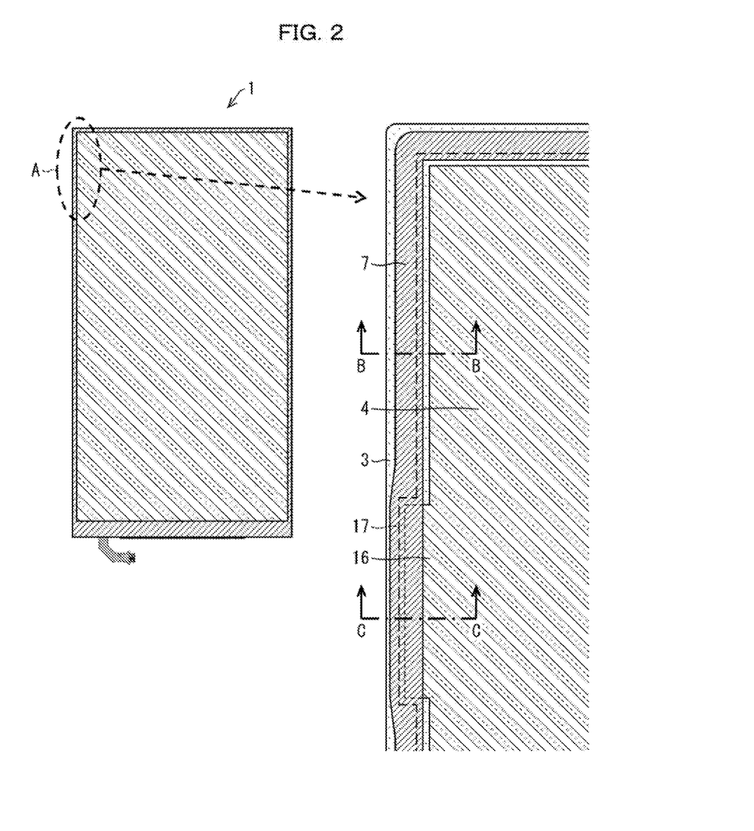

The following will discuss a position where the inclined surface 13 of the frame 3 is provided, with reference to FIG. 2. FIG. 2 shows an overall view of the planar light source device 1 in accordance with Embodiment 1 of the present invention and an enlarged view of a region A.

As illustrated in FIG. 2, the frame 3 is provided with a cut part 17. The optical sheet 4 is provided with a tab 16 formed at a position that corresponds to the position of the cut part 17 of the frame 3. The optical sheet 4 is supported by the frame 3 by fitting the tab 16 in the cut part 17.

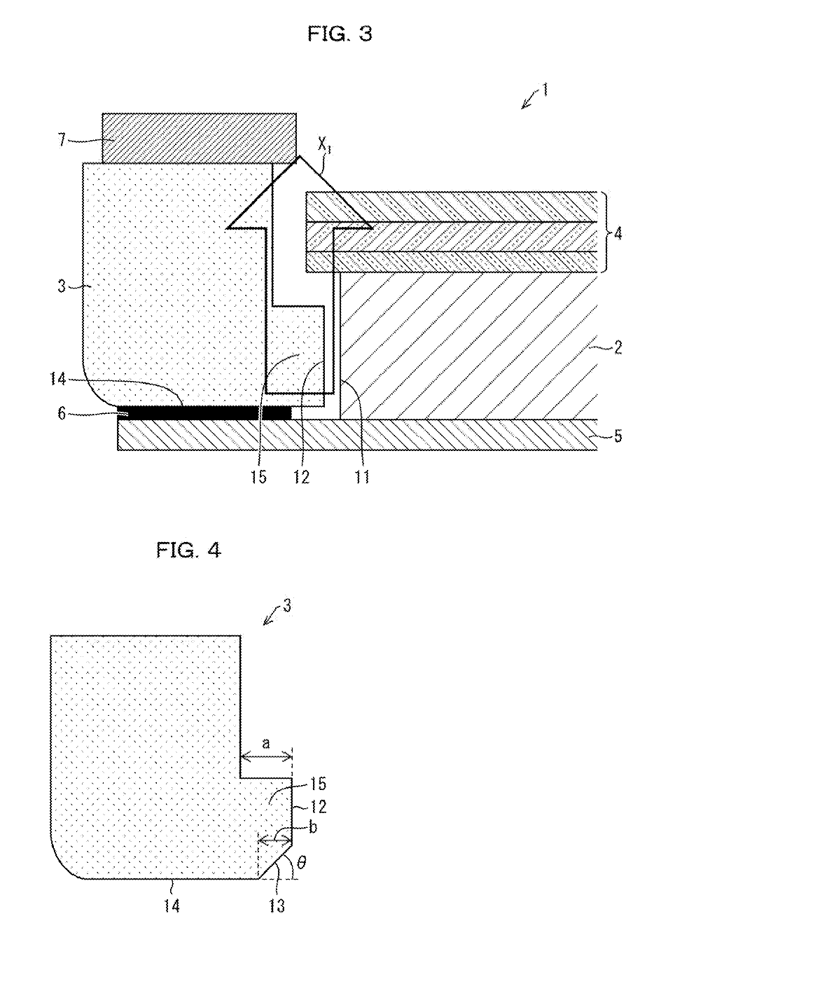

The inclined surface 13 of the frame 3 is formed at least at a portion where the cut part 17 of the frame 3 is not formed. For example, in a case where (i) the inclined surface 13 of the frame 3 is formed at a portion of the frame 3 at which portion the cut part 17 is not formed and (ii) the inclined surface 13 is not formed at a portion of the frame 3 at which portion the cut part 17 is formed, a cross sectional view of the portion where the cut part 17 is not formed (cross sectional view taken along line B-B in FIG. 2) is as illustrated in FIG. 1 while a cross sectional view of the portion where the cut part 17 is not formed (cross sectional view taken along line C-C in FIG. 2) is as illustrated in FIG. 3.

With this configuration, at the portion where the cut part 17 of the frame 3 is not formed, part of the light having leaked out through the lateral surface 11 of the light guide plate 2 enters a gap between the inclined surface 13 and the reflection sheet 5 and is absorbed by the light absorbing member 6. This consequently reduces light X₁ which, after having leaked out through the lateral surface 11 of the light guide plate 2, exits on the light exit plane side (FIG. 1). In contrast, at the portion of the frame 3 at which portion the cut part 17 is formed, no inclined surface 13 is formed. This accordingly does not lead to reduction of the light X₁ which, after having leaked out through the lateral surface 11 of the light guide plate 2, exits on the light exit plane side (FIG. 3).

In a liquid crystal display device, a portion where a tab of an optical sheet is not formed appears brighter, because of light which have leaked out of a light guide plate and further exited through the light exit plane. In contrast, at a portion where the tab of the optical sheet is formed, there is less light which has leaked out of the light guide plate and further exited through the light exit plane. As a result, the portion where the tab of the optical sheet is formed noticeably appears darker as compared to the portion where the tab of the optical sheet is not formed.

In light of the above, in the planar light source device 1 in accordance with Embodiment 1, the frame 3 is provided with the inclined surface 13 formed at least at the portion where the cut part 17 is not formed, so that at the portion, the light having leaked out through the lateral surface 11 of the light guide plate 2 is prevented from exiting on the light exit plane side. This makes it possible to reduce difference in brightness between a portion where the tab 16 of the optical sheet 4 is formed and a portion where the tab 16 is not formed.

Note that the position where the inclined surface 13 of the frame 3 is provided is not limited to the above example. For example, the inclined surface 13 of the frame 3 may be provided at both of the portion where the cut part 17 is formed and the portion where the cut part 17 is not formed. Further, some or all of the opposed surfaces 12 may be provided with the inclined surface 13. In this regard, the inclined surface 13 is not limited.

### Structure of Inclined Surface 13

The following will discuss a structure of the inclined surface 13 of the frame 3, with reference to FIG. 4. FIG. 4 is a cross sectional view illustrating a portion where the inclined surface 13 of the frame 3 is formed.

First, an angle which the inclined surface 13 of the frame 3 makes with a surface including the bottom surface 14 of the frame 3 is preferably 30 degrees to 60 degrees, and particularly preferably 45 degrees (i.e., the inclined surface 13 is a C chamfer). In a configuration where the angle which the inclined surface 13 of the frame 3 makes with the surface including the bottom surface 14 of the frame 3 is in the above range, the light having leaked out through the lateral surface 11 of the light guide plate 2 can be reflected toward the light absorbing member 6 between the inclined surface 13 and the reflection sheet 5 and efficiently guided to the light absorbing member 6.

Further, in a cross section along a vertical direction of the frame 3, the width b of the inclined surface 13 is preferably not less than ½ of the width a of the protrusion 15. In a configuration where the width b of the inclined surface 13 is within the above range, the light having leaked out through the lateral surface 11 of the light guide plate 2 can easily enter the gap between the inclined surface 13 and the reflection sheet 5. As a result, the light can be efficiently guided to the light absorbing member 6.

### Structure of Frame 3

In the configuration illustrated in FIG. 1, the bottom portion of the frame 3 has a shape including the protrusion 15 that protrudes toward the light guide plate 2. In the configuration discussed here, the inclined surface 13 is formed at at least a portion where the cut part 17 is not formed, which portion is part of at least one opposed surface 12 of the protrusion 15. However, the structure of the frame 3 is not limited to such a structure. For example, the frame 3 may have a shape that does not include the protrusion 15. In this configuration, the inclined surface 13 may be formed at least at a portion where the cut part 17 is not formed, which portion is part of an opposed surface 12 serving as an inner surface of the frame 3.

Note that a constituent material of the frame 3 is not particularly limited, and can be, for example, resin, sheet metal, or the like. Note however that the frame 3 is preferably made of a white material which does not absorb light. In such a configuration, the light having leaked out of the light guide plate 2 can be efficiently reflected back into the light guide plate 2.

### Embodiment 2

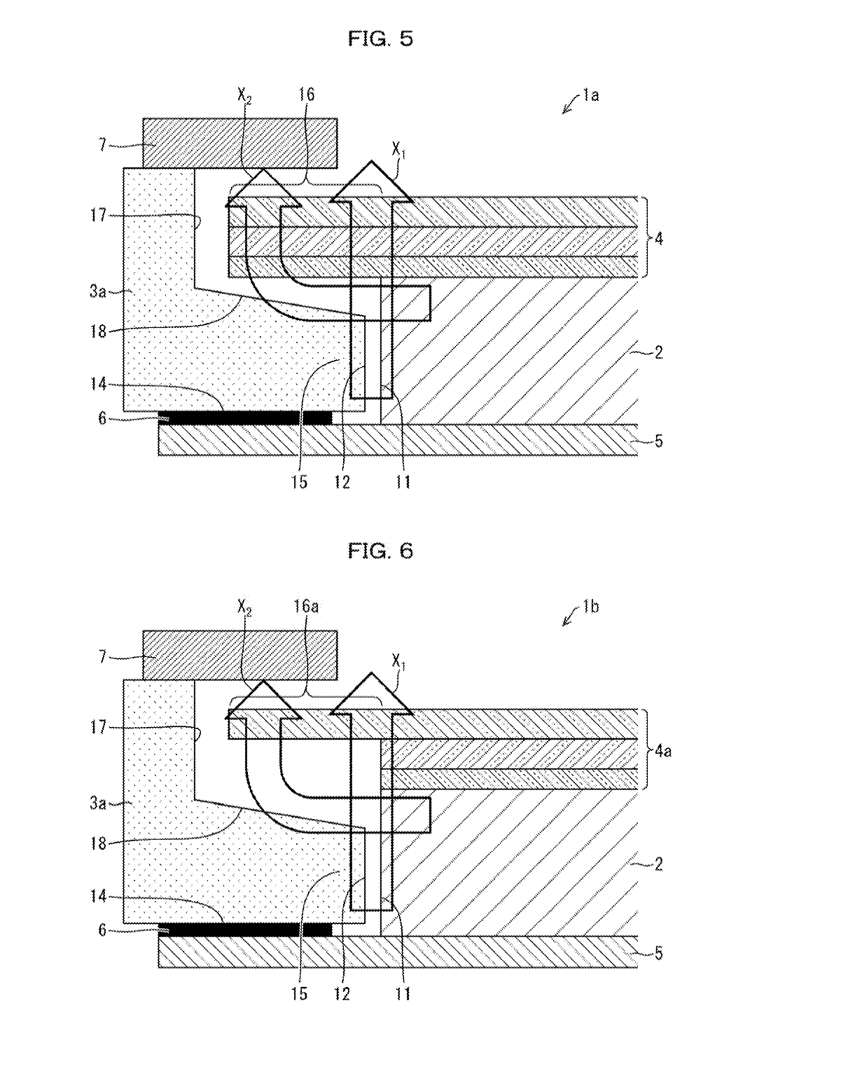

The following will discuss Embodiment 2 of the present invention, with reference to FIG. 5. Note that, for convenience of explanation, identical reference numerals are given to members which have respective functions identical with those described in Embodiment 1, and descriptions of the respective members are omitted.

FIG. 5 is a view schematically illustrating a cross section of a planar light source device 1a in accordance with Embodiment 2 of the present invention. This cross sectional view illustrates a portion of a frame 3a at which portion a cut part 17 is formed. As illustrated in FIG. 5, in the planar light source device 1a, the frame 3a has an inclined surface 18 (another inclined surface) formed so as to incline with respect to a direction perpendicular to a light exit plane and to face a light exit plan side. The inclined surface 18 here is formed at a portion where the cut part 17 is formed. The portion is part of at least one surface 12 of the frame 3a, which surface 12 (hereinafter, referred to as opposed surface 12) faces a lateral surface 11 of a light guide plate 2. In FIG. 5, a bottom portion of the frame 3a has a shape including a protrusion 15 that protrudes toward the light guide plate 2. The inclined surface 18 is formed at a portion where the cut part 17 is formed, which portion is part of at least one opposed surface 12 of the protrusion 15.

Since the frame 3a has the inclined surface 18, part of light having leaked out through the lateral surface 11 of the light guide plate 2 enters a gap between the inclined surface 18 of the frame 3a and an optical sheet 4. Then, the light is reflected by the inclined surface 18 and caused to exit on a light exit plane side. As a result, at the portion of the frame 3a at which portion the cut part 17 is formed, part of the light having leaked out through the lateral surface 11 of the light guide plate 2 becomes light X₂ which is caused to exit on the light exit plane side.

This consequently increases, at the portion of the frame 3a at which portion the cut part 17 is formed, an intensity of light which exits on the light exit plane side. This is because not only light X₁, which is reflected by the opposed surface 12 of the frame 3a and caused to exit on the light exit plane side, but also light X₂, which is reflected by the inclined surface 18 and caused to exit on the light exit plane side, are produced from the light having leaked out through the lateral surface 11 of the light guide plate 2.

Therefore, at the portion of the frame 3a at which portion the cut part 17 is not formed, the light having leaked out through the lateral surface 11 of the light guide plate 2 is prevented from exiting on the light exit plane side. At the same time, at the portion where the cut part 17 is formed, there is an increase in light which, after having leaked out through the lateral surface 11 of the light guide plate 2, exits on the light exit plane side. This makes it possible to reduce difference in brightness between a portion where a tab 16 of the optical sheet 4 is formed and a portion where the tab 16 is not formed.

An angle which the inclined surface 18 of the frame 3a makes with a surface parallel to the bottom surface 14 of the frame 3a is preferably not more than 45 degrees and particularly preferably 10 degrees to 30 degrees. In a configuration where the angle which the inclined surface 18 of the frame 3a makes with the surface parallel to the bottom surface 14 of the frame 3a is in the above range, the light having leaked out through the lateral surface 11 of the light guide plate 2 can be efficiently reflected toward the light exit plane side.

Not that some or all of the opposed surfaces 12 may be provided with the inclined surface 18. In this regard, the inclined surface 18 is not particularly limited.

Further, in the configuration illustrated in FIG. 5, the bottom portion of the frame 3a has a shape including the protrusion 15 that protrudes toward the light guide plate 2. In the configuration discussed here, the inclined surface 18 is formed at a portion where the cut part 17 is formed, which portion is part of at least one opposed surface 12 of the protrusion 15. However, the structure of the frame 3a is not limited to such a structure. For example, the frame 3a may have a shape that does not include the protrusion 15. In this configuration, the inclined surface 13 may be formed at a portion where the cut part 17 is formed, which portion is part of an opposed surface 12 serving as an inner surface of the frame 3a.

### Embodiment 3

The following will discuss Embodiment 3 of the present invention, with reference to FIG. 6. Note that, for convenience of explanation, identical reference numerals are given to members which have respective functions identical with those described in Embodiment 1 or 2, and descriptions of the respective members are omitted.

FIG. 6 is a view schematically illustrating a cross section of a planar light source device 1b in accordance with Embodiment 3 of the present invention. This cross sectional view illustrates a portion of a frame 3 at which portion a cut part 17 is formed. As illustrated in FIG. 6, among a plurality of sheets constituting an optical sheet 4a, only a sheet serving as a top surface (i.e., a sheet on a light exit plane side) is provided with a tab 16a. The tab 16a is fit in the cut part 17 of the frame 3a, so that the optical sheet 4a is supported by the frame 3a.

In this configuration, light X₁, which is reflected by an opposed surface 12 of the frame 3a and caused to exit on the light exit plane side, and light X₂, which is reflected by the inclined surface 18 and caused to exit on the light exit plane side, are produced from the light having leaked out through a lateral surface 11 of a light guide plate 2. The light X₁ and the light X₂ pass through only the tab 16a at the portion of the frame 3a at which portion the cut part 17 is formed.

This consequently increases, at the portion of the frame 3a at which portion the cut part 17 is formed, light which, after having leaked out through the lateral surface 11 of the light guide plate 2, passes through the tab 16a and exits through a light exit plane. Accordingly, it is possible to reduce difference in brightness between a portion where the tab 16a of the optical sheet 4a is formed and a portion where the tab 16a is not formed.

Note that even in a case where the planar light source device 1b in accordance with Embodiment 3 does not have the inclined surface 18, there is an increase in light which, after having leaked out through the lateral surface 11 of the light guide plate 2, passes through the tab 16a of the optical sheet 4a, so that it is possible to reduce difference in brightness between the portion where the tab 16a is formed and the portion where the tab 16a is not formed. Therefore, the present invention encompasses a configuration in which no inclined surface 18 is formed in the planar light source device 1b in accordance with Embodiment 3.

### Recap

A planar light source device 1 in accordance with Aspect 1 of the present invention includes: a light source which emits light outside; a light guide plate 2 which causes the light to exit outside through a light exit plane while guiding the light; an optical sheet 4 including a tab 16 and provided on a first side of the light guide plate 2, the first side being a side where the light exit plane is present; a frame 3 in which the light source, the light guide plate 2, and the optical sheet 4 are provided, the frame 3 having a cut part 17 in which the tab 16 of the optical sheet 4 is fit; and a light absorbing member 6 provided on a bottom surface 14 of the frame 3, the frame 3 having a first inclined surface 13 formed so as to incline with respect to a direction perpendicular to the light exit plane and to face in a direction opposite to the light exit plane, the first inclined surface 13 being formed at least at a first portion where the cut part 17 is not formed, the first portion being part of at least one surface of the frame 3, the at least one surface of the frame facing a lateral surface 11 of the light guide plate 2.

With the above configuration, at the first portion of the frame 3 at which first portion the cut part 17 is not formed, part of the light having leaked out through the lateral surface 11 of the light guide plate 2 enters a gap between the first inclined surface 13 and the reflection sheet 5. This part of light is absorbed by the light absorbing member 6. This reduces light which, after having leaked out through the lateral surface 11 of the light guide plate 2, exits on the light exit plane side. Accordingly, in the planar light source device 1 in accordance with an aspect of the present invention, the frame 3 has the first inclined surface 13 formed at least at the first portion where the cut part 17 is not formed, so that at the first portion, the light having leaked out through the lateral surface 11 of the light guide plate 2 is prevented from exiting on the light exit plane side. This makes it possible to reduce difference in brightness between a portion where the tab 16 of the optical sheet 4 is formed and a portion where the tab 16 is not formed.

Further, the planar light source device 1 in accordance with Aspect 2 of the present invention is arranged such that in the above Aspect 1, the first inclined surface 13 makes an angle of 45 degrees with a plane including the bottom surface 14 of the frame 3.

With the above configuration, the light having leaked out through the lateral surface 11 of the light guide plate 2 can be reflected toward the light absorbing member 6 between the first inclined surface 13 and the reflection sheet 5 and efficiently guided to the light absorbing member 6.

Further, the planar light source device 1 in accordance with Aspect 3 of the present invention may be configured such that, in the above Aspect 1 or 2: the frame 3 has a protruding bottom portion (protrusion 15) which protrudes toward the light guide plate 2; and the first inclined surface 13 is formed at least at the first portion where the cut part 17 is not formed, the first portion being part of at least one surface of the protruding bottom portion, the at least one surface of the protruding bottom portion facing the lateral surface 11 of the light guide plate 2.

Further, the planar light source device 1 in accordance with Aspect 4 of the present invention is configured such that in the above Aspect 3: in a cross section of the frame 3 along a vertical direction, the width b of the first inclined surface 13 is not less than half the width a of the protruding bottom portion (protrusion 15).

With the above configuration, the light having leaked out through the lateral surface 11 of the light guide plate 2 can easily enter the gap between the first inclined surface 13 and the reflection sheet 5. As a result, the light can be efficiently guided to the light absorbing member 6.

Further, the planar light source device 1 in accordance with Aspect 5 of the present invention is configured to further include, in any one of the above Aspects 1 through 3, a reflection sheet 5 provided on a second side of the light guide plate 2, the second side being opposite to the first side where the light exit plane is present, the light absorbing member 6 being a double-sided black tape for fixing the reflection sheet 5 to the bottom surface 14 of the frame 3.

This configuration allows the light absorbing member 6 to have both of (i) a function as a member for absorbing the light having leaked out through the lateral surface 11 of the light guide plate 2 and (ii) a function as a member for fixing the reflection sheet 5 to the bottom surface of the frame 3.

The planar light source device 1a in accordance with Aspect 6 of the present invention is configured such that in any one of the above Aspects 1 through 5: the frame 3a has a second inclined surface 18 formed so as to incline with respect to the direction perpendicular to the light exit plane and to face the first side where the light exit plane is present, the second inclined surface 18 being formed at a second portion where the cut part 17 is formed, the second portion being part of the at least one surface 12 of the frame 3a, the at least one surface of the frame facing the lateral surface 11 of the light guide plate 2.

With the above configuration, at the first portion of the frame 3a at which first portion the cut part 17 is not formed, the light having leaked out through the lateral surface 11 of the light guide plate 2 is prevented from exiting on a light exit plane side. At the same time, at the second portion where the cut part 17 is formed, the above configuration increases light which, after having leaked out through the lateral surface 11 of the light guide plate 2, exits on the light exit plane side. This makes it possible to reduce difference in brightness between the portion where the tab 16 of the optical sheet 4 is formed and the portion where the tab 16 is not formed.

Further, the planar light source device 1a in accordance with Aspect 7 of the present invention may be configured such that in Aspect 6: the frame 3a has a protruding bottom portion (protrusion 15) which protrudes toward the light guide plate 2; and the second inclined surface 18 is formed at the second portion where the cut part 17 is formed, the second portion being part of the protruding bottom portion.

In addition, the scope of the present invention encompasses a liquid crystal display device which includes: a planar light source device 1 as described in any one of the above Aspects 1 through 7; and a liquid crystal panel.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a, 1b planar light source device
2 light guide plate
3, 3a frame
4, 4a optical sheet
5 reflection sheet
6 light absorbing member
7 light shielding tape
13, 18 inclined surface
16, 16a tab
17 cut part

1. A planar light source device comprising:
a light source which emits light outside;
a light guide plate which causes the light to exit outside through a light exit plane while guiding the light;
an optical sheet including a tab and provided on a first side of the light guide plate, the first side being a side where the light exit plane is present;
a frame in which the light source, the light guide plate, and the optical sheet are provided, the frame having a cut part in which the tab of the optical sheet is fit; and
a light absorbing member provided on a bottom surface of the frame,
the frame having a first inclined surface formed so as to incline with respect to a direction perpendicular to the light exit plane and to face in a direction opposite to the light exit plane, the first inclined surface being formed at least at a first portion where the cut part is not formed, the first portion being part of at least one surface of the frame, the at least one surface of the frame facing a lateral surface of the light guide plate.

2. The planar light source device as set forth in claim 1, wherein:
the first inclined surface makes an angle of 45 degrees with a plane including the bottom surface of the frame.

3. The planar light source device as set forth in claim 1, wherein:
the frame has a protruding bottom portion which protrudes toward the light guide plate; and
the first inclined surface is formed at least at the first portion where the cut part is not formed, the first portion being part of at least one surface of the protruding bottom portion, the at least one surface of the protruding bottom portion facing the lateral surface of the light guide plate.

4. The planar light source device as set forth in claim 3, wherein:
in a cross section of the frame along a vertical direction, a width of the first inclined surface is not less than half a width of the protruding bottom portion.

5. The planar light source device as set forth in claim 1, further comprising:
a reflection sheet provided on a second side of the light guide plate, the second side being opposite to the first side where the light exit plane is present,
the light absorbing member being a double-sided black tape for fixing the reflection sheet to the bottom surface of the frame.

6. The planar light source device as set forth in claim 1, wherein:
the frame has a second inclined surface formed so as to incline with respect to the direction perpendicular to the light exit plane and to face the first side where the light exit plane is present, the second inclined surface being formed at a second portion where the cut part is formed, the second portion being part of at least one surface of the frame, the at least one surface of the frame facing the lateral surface of the light guide plate.

7. The planar light source device as set forth in claim 6, wherein:
the frame has a protruding bottom portion which protrudes toward the light guide plate; and
the second inclined surface is formed at the second portion where the cut part is formed, the second portion being part of at least one surface of the protruding bottom portion, the at least one surface of the protruding bottom portion facing the lateral surface of the light guide plate.

8. A liquid crystal display device comprising:
a planar light source device as recited in claim 1; and
a liquid crystal panel.
